(19) United States
(12) Patent Application Publication
(10) Pub. No.: US 2017/0317956 A1
(43) Pub. Date: Nov. 2, 2017

(54) METHOD AND SYSTEM OF ELECTRONIC MEMORIAL EXPRESSION TO THE DECEASED

(71) Applicant: Richard D. Yelvington, Largo, FL (US)

(72) Inventor: Richard D. Yelvington, Largo, FL (US)

(21) Appl. No.: 15/144,248

(22) Filed: May 2, 2016

(51) Int. Cl. H04L 12/58

(52) U.S. Cl. CPC H04L 51/046; H04L 51/32; H04L 51/08; H04L 51/10

(57) ABSTRACT

A system and method for collecting and transmitting messages to the deceased.

### BACKGROUND OF THE INVENTION

### 1. Technical Field

This invention relates to a method for transmitting a message to the deceased, such as a memorial expression, and sharing the transmission over a communications medium, e.g., social media. This invention also relates to an application, such as a mobile application (in the vernacular typically referred to as an app), for transmitting a message in the form of a memorial expression to the deceased. This invention also relates to a method and application for sending messages to no recipient in particular or to a recipient to whom the sender does not wish to receive the message.

### 2. Prior Art

There exists a need in the human spirit express oneself to others to whom they are emotionally close. For example, when a friend or family member passes away, the need to express one's feelings to that person does not cease.

We read stories of people writing letters to deceased loved ones and then burning the letters. We read of people spending hours in prayer asking their god to look over those who have passed away. These methods are a means to try and replace a lost relationship and/or grieve the loss. Under some belief systems, these attempts are literally an attempt to contact the deceased. No method appears to exist outside these means to try and console the bereaved.

Accordingly, there is a need for a method and system of electronic expression for sending a message to the deceased whereby the sender can compose and send such a message via social media, smart phones, computers, tablets, and other devices, via an app. It is to this need and others that the present invention is directed.

### BRIEF SUMMARY OF THE INVENTION

Briefly, the present invention provides a method of creating, transmitting, and storing messages to the deceased in a software environment, e.g., a smartphone application environment.

In another embodiment, the method comprises creating, transmitting, and storing messages to the deceased in a software environment, e.g., a smartphone application environment, and either contemporaneously, or later, encoding the message configured for radio telescope transmission to the cosmos. Such encoding may include message compression or code compression to maximize transmission efficiency.

In another embodiment, the method comprises creating, transmitting, and sharing the message with another person to whom the deceased was related or was in a friendship relationship with the deceased.

In another embodiment, there is provided a system for creating, storing, transmitting, and sharing messages to the deceased.

A complete understanding of the present invention may be obtained by reference to the accompanying drawings, when considered in conjunction with the following detailed description of preferred embodiments.

### BRIEF DESCRIPTION OF THE FIGURES

FIG. 1 is a block diagram of a messaging system according to one example of the disclosure.

FIG. 1A is a flowchart of a process for creating and transmitting a message according to the messaging system of the disclosure.

FIG. 2 is a block diagram of a data processing device for the messaging system of the disclosure.

FIG. 3 is a graphic representation of an initial website interface of the system of the disclosure.

FIG. 4 is a graphic representation of an input and status website interface of the messaging system of the disclosure.

FIG. 5 is a graphic representation of an input and status website interface of the messaging system as found on a mobile computing device, e.g., a smartphone, according to the disclosure.

FIG. 6 is a graphic representation of a transmission status interface as found on a mobile computing device, e.g., a smartphone, according to the disclosure.

FIG. 7 is a website interface of the messaging system of the disclosure wherein a list of memorials of the deceased is listed.

FIG. 8 is a schematic representation of a portable computing device configured to collect and transmit messages to the deceased.

FIG. 9 is a schematic representation of a software architecture configured to collect and transmit messages to the deceased.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications, and equivalents, which may be included within the spirit and scope of the invention as defined by the appended claims.

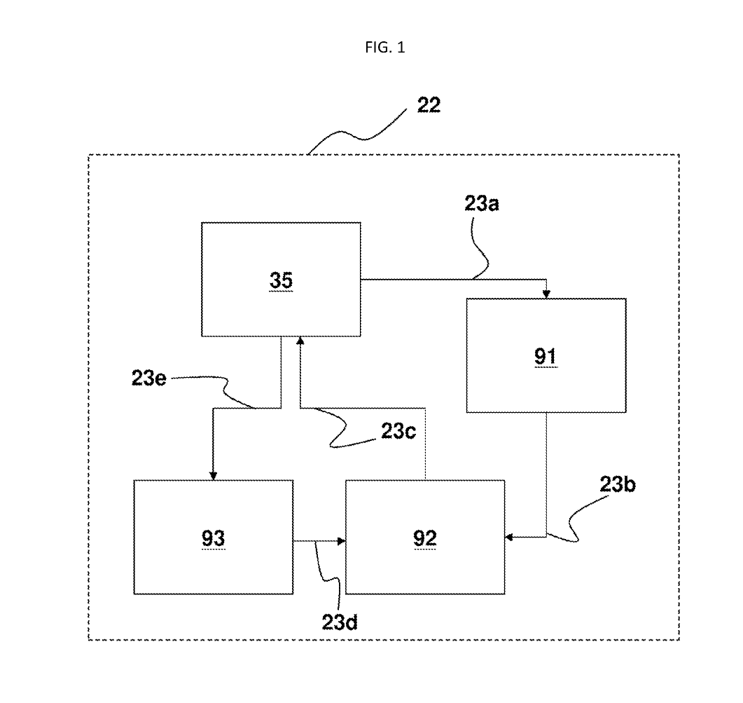

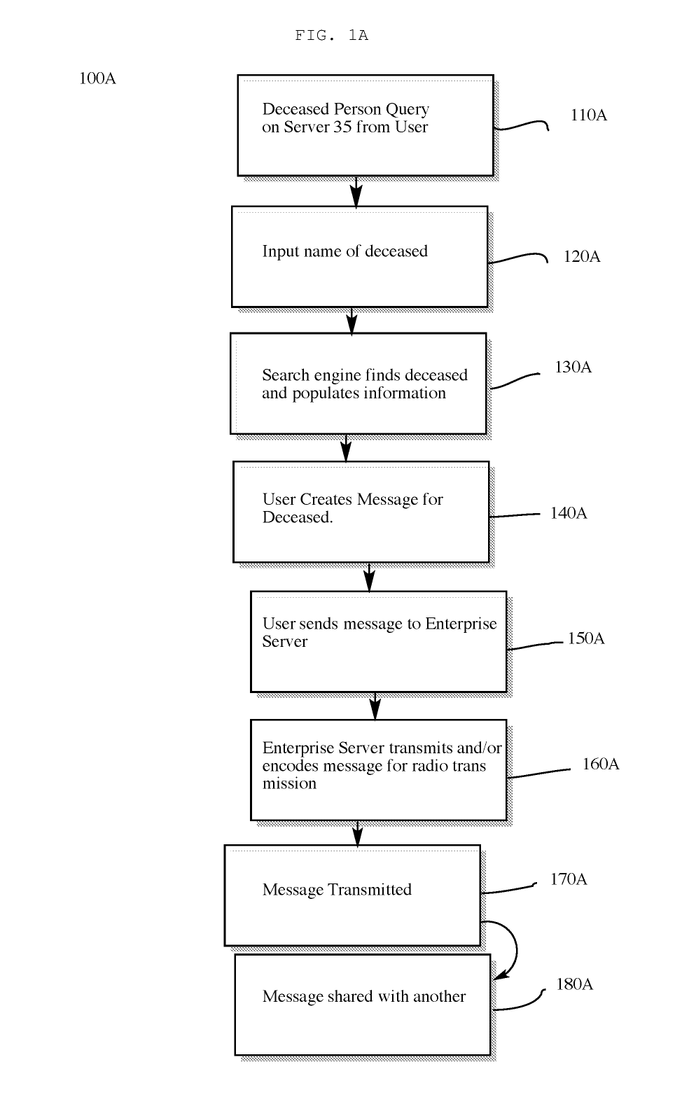

Referring now to FIG. 1, the first exemplary embodiment of the present invention is a messaging system for the deceased (22) comprising a messaging server (35) and multiple subsystems, which include at least one enterprise system (91), at least one search engine (92) and at least one end-user system (93). These subsystems (91, 92, 93) are each connected to the messaging server (35) via different data communication channels (23a, 23b, 23c, 23d, 23e). These data communication channels may establish a point-to-point data path. This can be accomplished through either a private communication network, a public network such as the Internet, or a virtual private network (VPN), or combinations thereof. It may traverse one or more local area network (LAN), metropolitan area network (MAN), wide area network (WAN), or combinations thereof. Each of such networks may be implemented using leased lines, optical fiber, wireless technologies, or other networking technologists, or combinations thereof.

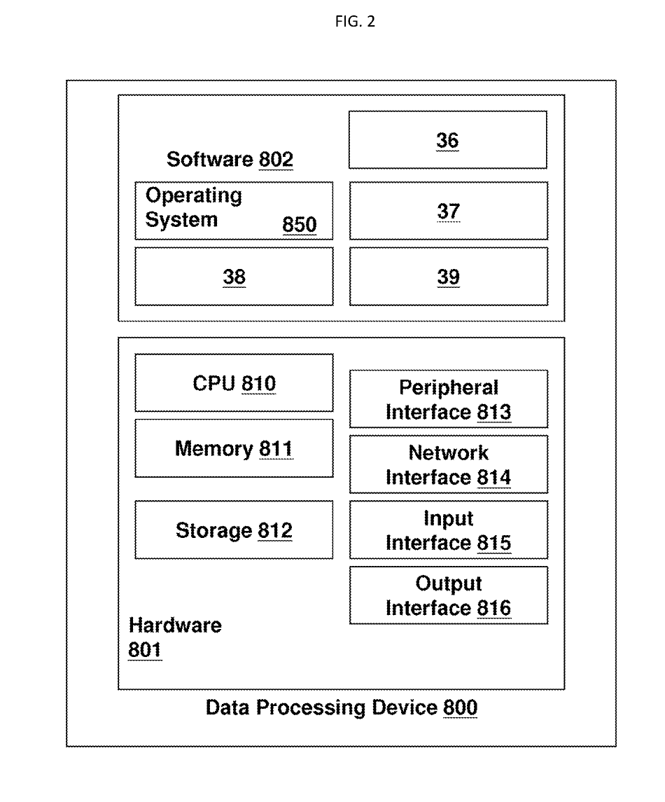

The system block diagram shown in FIG. 1 depicts one embodiment of the present invention that employs distributed computing architecture, where the messaging server (35), the enterprise system (91), the search engine (92), and the end-user system (93) are physically located apart from each other. Each of these systems can be a data processing system (800) as shown in FIG. 2. This system (800) consisting of both the hardware (801) and software components (802) that can be used to implement the embodiment of the present invention. The hardware components further comprises a Central Processing Unit (CPU) (810), memory (811), storage (812), and multiple interfaces such as the peripheral interface (813), network interface (814), input interface (815) and output interface (816).

CPU (810) can be a single microprocessor or multiple processors combined together. Memory (811) can include read-only memory, random-access memory or other memory technologies, singly or jointly combined. Storage (812) typically includes persistence storage such as magnetic hard disk, floppy disk, optical storage devices such as CD-ROM, and semiconductor storage devices such as flash memory cards, or other storage technologies, singly or in combination. Network interface (814) enables the data processing device (800) to exchange information with the external data communication network such as a Personal Area Network (PAN), a Local Area Network (LAN), a Wide Area Network (WAN), the Internet, and other data communication network architectures, upon which the data communication channel is established. The network interface (814) can include an Ethernet interface, a Wireless LAN interface device, a Bluetooth interfacing device and other networking devices, singly or in combination.

Software (802) further includes the operating system (850), and one or more software implementations of those systems in FIG. 1.

With reference to FIG. 1A, in an embodiment, the messaging server 35 may follow a method, or algorithm 100A, for sending a message for an addressee, with the express intent that the message not be received by the intended addressee. An example addressee is a deceased person, such as a deceased parent or other relative. For the purposes of this disclosure, all such addressees will be referred to sometimes as simply the deceased or a deceased person.

In a first step 110A, the deceased person is queried or identified to the system 35 by a user wishing to send the message. In step 120A, the user may provide additional information about the deceased to the system, e.g., the deceased's name, or the user may bypass such input and use a search engine or module 130A to populate information about the deceased. In step 140A, the user creates the message, and subsequently in step 150A sends the message with the server 35 and/or enterprise system 91. In a step 160A the message is encoded and/or prepared for radio transmission. Subsequently the message is transmitted in step 170A. There is no need for the message to be received by the addressee (e.g., the departed person), as the steps of and processes for sending the message is a primary feature of the invention. Optionally, however, the message may be shared 180A on a medium, e.g., a social media such as Twitter®, Facebook®, LinkedIn®, a website, an email, a text message, a phone call, and the like as known to a person of ordinary skill in the art.

In another embodiment, the message may be encoded and transmitted to outer space, e.g., the cosmos, by a radio transmitter and/or radio telescope with transmission capacity. In an embodiment, the user may pick the transmission frequency, e.g., a transmission frequency that may penetrate space. For example, the user may pick the 21 centimeter line, from 608 to 614 MHz, 1,420 to 1,666 MHz. In this manner, should there be a return signal, a major radio telescope on the earth may detect the frequency if reflected.

In this manner, and in an embodiment, the messenger may send a message that will be beamed into the universe and the radio waves travel for infinity. Conveniently, this method will allow the bereaved to send special occasion messages to the deceased, e.g., birthday greetings, a Christmas message, or a message of remembrance.

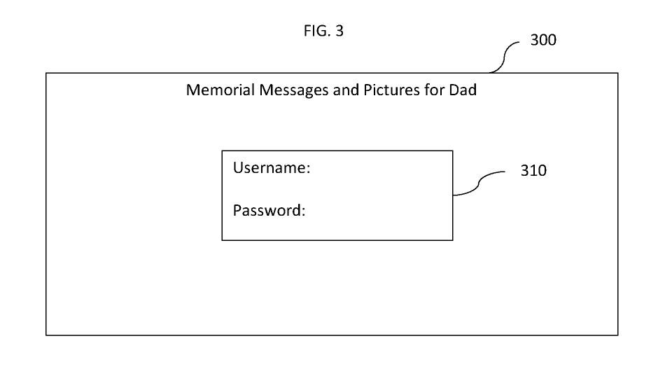

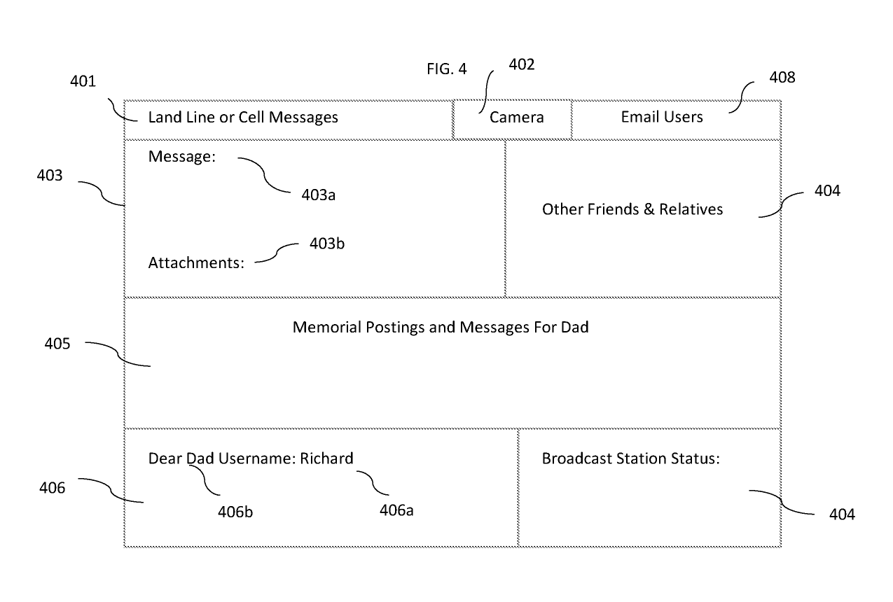

In another embodiment, the system may comprise a series of screen displays operatively related to system 22 that portray one or more messages sent to the intended deceased. With reference to FIG. 3, a first interaction may be a login screen 300 where a user has been assigned or registers with system 35 and may have access 310 to the messaging function of system 35. After entry into the system via username and password, the user may interact with a screen interface 400 such as that in FIG. 4. Interface 400 provides several graphical sectors or regions with imbedded code or hypertext markup language (HTML), or Adobe® Flash code for messaging creation and status regarding a message to a deceased. Region 406A may identify the username of the user of the system 22 and the account (“Dear Dad”) name 406B. In an embodiment, the name of the account may be e.g., “Dear Dad” or “Dear Darling” or “Dear “name of deceased.” Region 401 may display the text or transcription of a landline phone call voicemail left in system 22 for the deceased. In an alternative embodiment, the system 22 may accept text messages to the deceased and those may be displayed in, e.g., region 401. Region 402 may provide access to a camera to capture an image of the user and/or record the image in system 22. Region 408 may provide a list of email address and/or social media addresses for users of the system 22 and/or that have provided memorials and/or left memorial messages to be transmitted to the deceased. Region 403 may provide an interactive messaging application to which attachments 403b, e.g., letters, pictures, or other data files, may be associated with message 403a. Such attachments 403b may be encoded for transmission along with the message 403a. Region 404 may provide a listing of friends and/or relatives, for example, that have provided memorials and/or left memorial messages to be transmitted to the deceased. Region 405 may provide a listing of all or a portion of memorial postings and messages for the deceased, e.g., Dad. Region 407 may provide a transmission status (e.g., Yes, No, pending) to the user.

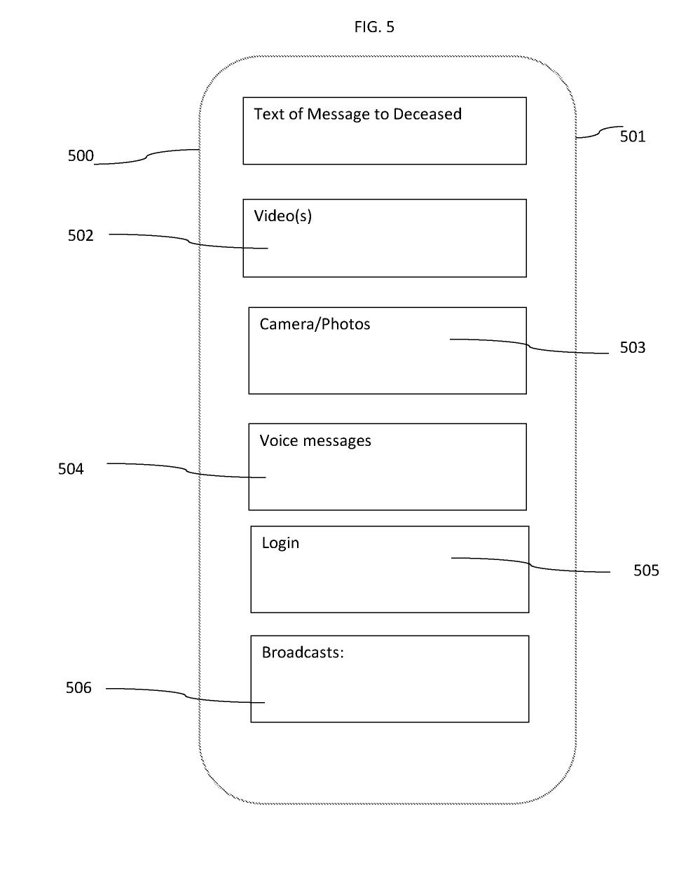

With reference to FIG. 5, in another embodiment, the system may comprise a series of screen displays on an application (“app”) residing on a mobile device, e.g., a smartphone, operatively related to system 22 that portray one or more messages sent to the intended deceased. After entry into the app, the user may interact with a screen interface 500 such as that in FIG. 5. Interface 500 may provide several graphical sectors or regions with code, e.g., imbedded code or hypertext markup language (HTML), or Adobe® Flash code for messaging creation and status regarding a message to a deceased. Region 505 may display the login credentials of the smartphone user. Region 501 may provide an interface to input a message for the deceased. Region 502 and Region 503 may provide an interface to record a video and/or take or upload a photo, respectively. Region 504 may provide an interactive module to capture a voicemail from the smartphone. Region 506 may provide a broadcast status to the smartphone user.

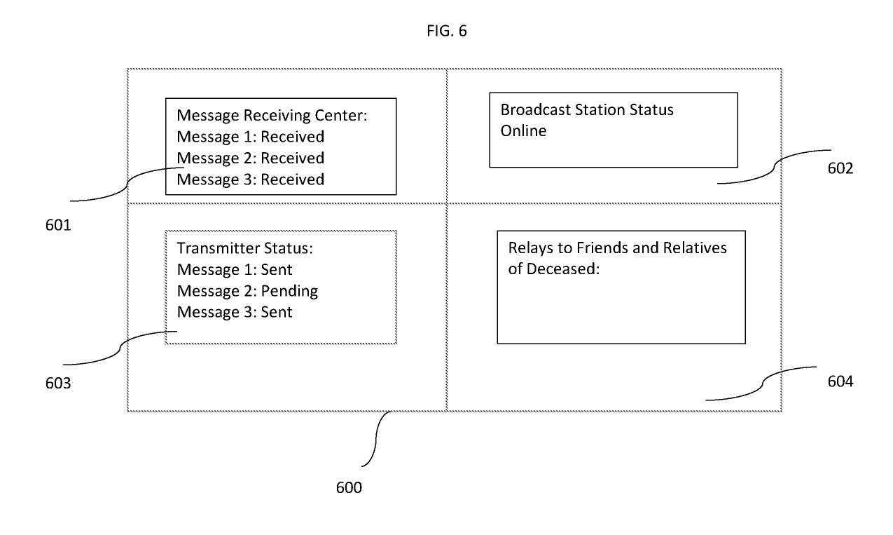

In another embodiment, region 407 and/or region 506 upon a click, or entry into the region may lead to a transmission status window 600 as shown in FIG. 6. Region 601 may provide the status of each message received at a radio transmitter or radio transmitter facility. Region 602 may provide the status of a transmission facility and/or the waiting time until the transmission takes place. Region 603 may provide a message transmission status for each message shown received in region 601. Region 604 may provide, e.g., a transmission relay to friends and relatives of the deceased. In an embodiment, the friends and relatives of the deceased may subscribe to a service of transmissions sent to space to also be transmitted to the friends and relatives.

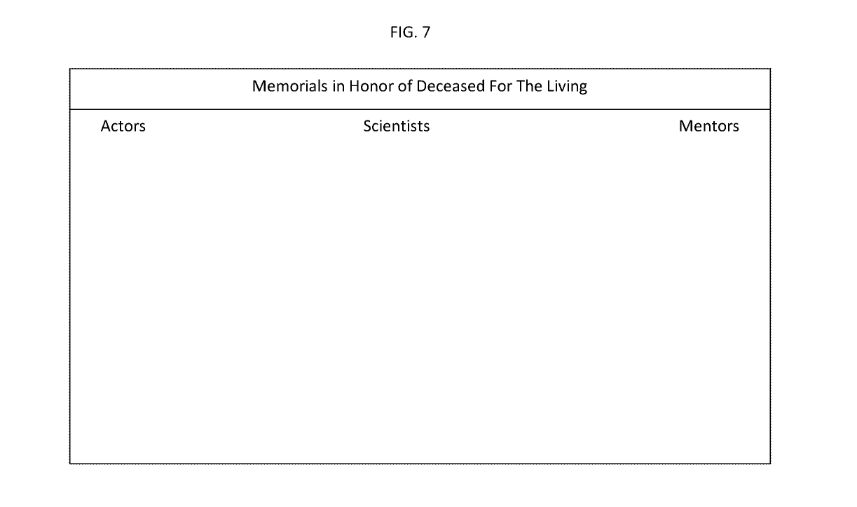

In another embodiment, the website may provide a list of memorials in honor of the deceased, e.g., as provided in FIG. 7.

It should be understood for those skilled in the art that the division between hardware and software is a conceptual division for ease of understanding and is somewhat arbitrary. Furthermore, the application software systems may be executed in a distributed computing environment. The software program and its related databases can be stored in a separate file server or database server and are transferred to the local host for execution. The data processing device (800) as shown in FIG. 2 is therefore an exemplary embodiment of how it can be implemented. Those skilled in the art will appreciate that alternative embodiments can be adopted to implement the present invention.

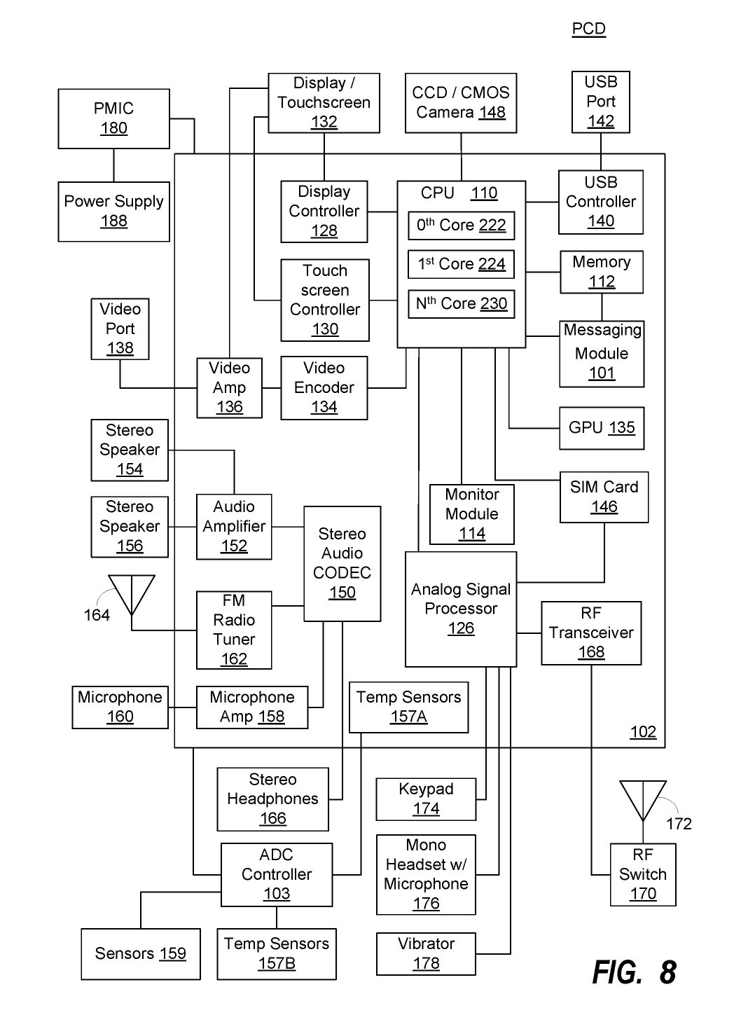

FIG. 8 is a functional block diagram illustrating an exemplary, non-limiting aspect of a portable computing device (“PCD”) for implementing the messaging methods and systems. The PCD may be in the form of a wireless telephone in some embodiments. As shown, the PCD includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) also may be employed as understood by one of ordinary skill in the art.

In general, messaging module 101 may be formed from hardware and/or firmware and may be responsible for determining when certain sensor readings should be taken and calculating a fitness factor according to one or more fitness factor algorithms. It is envisioned that messaging algorithms in some embodiments may be customizable by a user.

As illustrated in FIG. 8, a display controller 128 and a touch screen controller 130 are coupled to the digital signal processor 110. A touch screen display 132 external to the on-chip system 102 is coupled to the display controller 128 and the touch screen controller 130. The PCD may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core CPU 110. A video amplifier 136 is coupled to the video encoder 134 and the touch screen display 132. A video port 138 is coupled to the video amplifier 136. As depicted in FIG. 8, a universal serial bus (“USB”) controller 140 is coupled to the CPU 110. Also, a USB port 142 is coupled to the USB controller 140. A memory 112, which may include a PoP memory, a cache 116, a mask ROM/Boot ROM, a boot OTP memory, a DDR memory 115 may be coupled to the CPU 110. A subscriber identity module (“SIM”) card 146 may be coupled to the CPU 110. Further, as shown in FIG. 8, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 8, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 8 shows that a microphone amplifier 158 may be coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 8 further indicates that a radio frequency (“RF”) transceiver 168 may be coupled to the analog signal processor 126. An RF switch 170 may be coupled to the RF transceiver 168 and an RF antenna 172. A keypad 174 may be coupled to the analog signal processor 126. Also, a headset with a microphone 176 may be coupled to the analog signal processor 126. Further, a vibrator device 178 may be coupled to the analog signal processor 126. FIG. 8 also shows that a power supply 188, for example a battery, is coupled to the on-chip system 102 through a power management integrated circuit (“PMIC”) 180. In a particular aspect, the power supply 188 includes a rechargeable DC battery or a DC power supply that is derived from an alternating current (“AC”) to DC transformer that is connected to an AC power source. In another particular aspect, the power supply 188 includes a kinetically rechargeable DC battery.

The CPU 110 may be coupled to one or more internal, on-chip thermal sensors 157A as well as one or more external, off-chip thermal sensors 157B and physiological sensors 159. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller (not shown). However, other types of thermal sensors 157 may be employed.

The touch screen display 132, the video port 138, the USB port 142, the camera 148, the first stereo speaker 154, the second stereo speaker 156, the microphone 160, the FM antenna 164, the headphones 166, the RF switch 170, the RF antenna 172, the keypad 174, the headset 176, the vibrator 178, thermal sensors 157B, physiological sensors 159, the PMIC 180 and the power supply 188 are external to the on-chip system 102. It will be understood, however, that one or more of these devices depicted as external to the on-chip system 102 in the exemplary embodiment of a PCD in FIG. 8 may reside on chip 102 in other exemplary embodiments.

In a particular aspect, one or more of the method steps described herein may be implemented by executable instructions and parameters stored in the memory 112 or as form the messaging module 101. Further, the messaging module 101, the memory 112, the instructions stored therein, or a combination thereof may serve as a means for performing one or more of the method steps described herein.

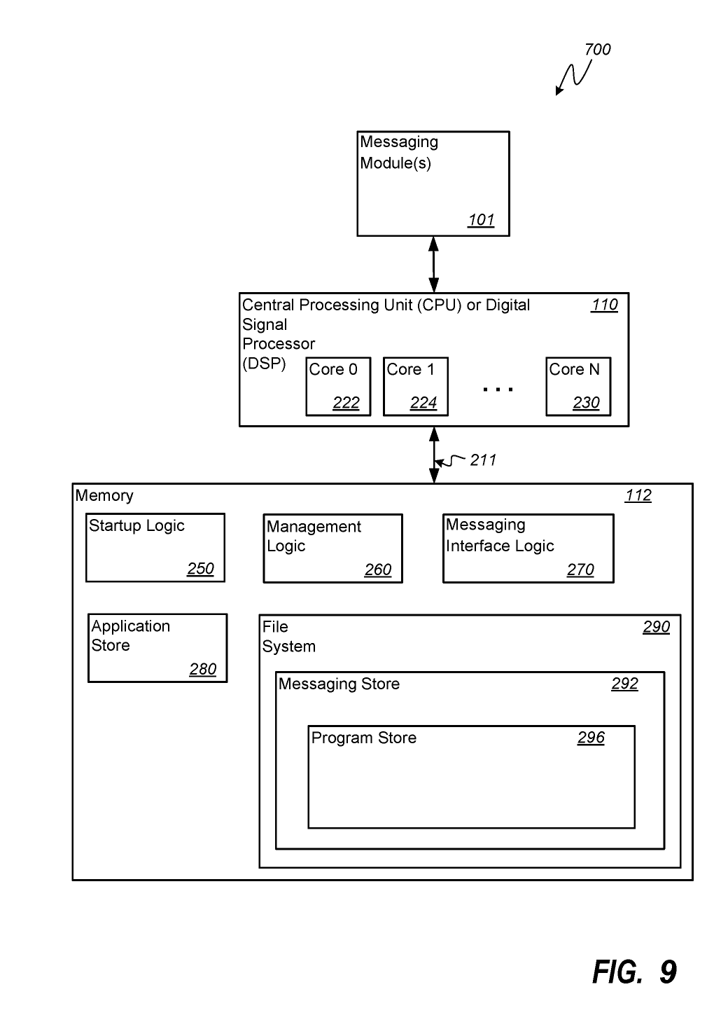

FIG. 9 is a schematic diagram illustrating an exemplary software architecture 700 for messaging embodiments. As illustrated in FIG. 9, the CPU or digital signal processor 110 is coupled to the memory 112 via main bus 211. Similarly, it will be understood that the messaging module 101 and the CPU 110 may reside within one or multiple data processing systems 800

The CPU 110, as noted above, is a multiple-core processor having N core processors. That is, the CPU 110 includes a first core 222, a second core 224, and an Nth core 230. As is known to one of ordinary skill in the art, each of the first core 222, the second core 224, and the Nth core 230 are available for supporting a dedicated application or program. Alternatively, one or more applications or programs may be distributed for processing across two or more of the available cores.

The CPU 110 may receive commands from the fitness factor module(s) 101 that may comprise software and/or hardware. If embodied as software, the module(s) 101 comprise instructions that are executed by the CPU 110 that issues commands to other application programs being executed by the CPU 110 and other processors.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the Nth core 230 via one or more shared caches and they may implement message or instruction passing via network topologies such as bus, ring, mesh, and crossbar topologies.

Bus 211 may include multiple communication paths via one or more wired or wireless connections, as is known in the art and described above in the definitions. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

When the logic used by the PCD implemented in software, as is shown in FIG. 9, it should be noted that one or more of startup logic 250, management logic 260, messaging interface logic 270, applications in application store 280 and portions of the file system 290 may be stored on any computer-readable medium for use by, or in connection with, any computer-related system or method. In the context of this document, a computer-readable medium is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), Flash, and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the messaging interface logic 270 are implemented in hardware, the various logic may be implemented with any or a combination of the following technologies, which are each well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 112 is a non-volatile data storage device such as a flash memory or a solid-state memory device. Although depicted as a single device, the memory 112 may be a distributed memory device with separate data stores coupled to the digital signal processor 110 (or additional processor cores).

The startup logic 250 includes one or more executable instructions for selectively identifying, loading, and executing a select program for generating a message. The startup logic 250 may identify, load and execute a messaging program. An exemplary select program may be found in the program store 296 of the embedded file system 290. The exemplary select program, when executed by one or more of the core processors in the CPU 110 may operate in accordance with one or more signals provided by the messaging module 101.

The management logic 260 includes one or more executable instructions for terminating a CTM program on one or more of the respective processor cores, as well as selectively identifying, loading, and executing a more suitable replacement program. The management logic 260 is arranged to perform these functions at run time or while the PCD is powered and in use by an operator of the device. A replacement program, which may be customized by a user in some CTM embodiments, may be found in the program store 296 of the embedded file system 290.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260. By way of example, the inputs may include a change to the weight of parameters used to generate a customized fitness factor.

The interface logic 270 enables a manufacturer to controllably configure and adjust an end user's experience under defined operating conditions on the PCD 100. When the memory 112 is a flash memory, one or more of the startup logic 250, the management logic 260, the interface logic 270, the application programs in the application store 280 or information in the embedded file system 290 may be edited, replaced, or otherwise modified. In some embodiments, the interface logic 270 may permit an end user or operator of the PCD to search, locate, modify or replace the startup logic 250, the management logic 260, applications in the application store 280 and information in the embedded file system 290. The operator may use the resulting interface to make changes that will be implemented upon the next startup of the PCD. Alternatively, the operator may use the resulting interface to make changes that are implemented during run time.

The embedded file system 290 includes a hierarchically arranged fitness factor store 292. In this regard, the file system 290 may include a reserved section of its total file system capacity for the storage of information for the configuration and management of the various messaging algorithms used by the PCD.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

While the invention has been described in connection with certain preferred embodiments, it is not intended to limit the spirit or scope of the invention to the particular forms set forth, but is intended to cover such alternatives, modifications, and equivalents as may be included within the true spirit and scope of the invention as defined by the appended claims.

What is claimed is:

1. A system for sending a message with the express intent that the message not be received by an intended addressee, comprising:
a) a data processing device configured to collect a message;
b) an electromagnetic transmitter; and
c) a message processing device to encode and/or transmit the message to the electromagnetic transmitter,
whereby the message is transmitted from the electromagnetic transmitter with the express intent that the message not be received by the intended addressee.

2. The system of claim 1, wherein the data processing device and the message processing device are the same device.

3. The system of claim 1, wherein the data processing device is configured to share the message with at least one person other than the intended addressee.

4. The system of claim 3, wherein the share is effected by a transmission selected from the group consisting of email, a webpage, social media, cellphone text messaging, and combinations thereof.

5. The system of claim 1, further comprising means to transmit an attachment with the message.

6. The system of claim 5, wherein the attachment is a photo.

7. The system of claim 5, wherein the attachment is a voicemail.

8. The system of claim 5 wherein the attachment is a text message.

9. The system of claim 1, wherein the intended addressee is a deceased person.

10. The system of claim 9 configured to allow a user to display a memorial gift or memorial message in honor of the deceased.

11. The system of claim 10 wherein the memorial gift or memorial message is shared with another.

11. The system of claim 1 wherein the data processing device is a portable computing device.

12. A system for sending a message with the express intent that the message not be received by an intended addressee, comprising:
a) a software application residing on a device having a CPU capable of running the software application, the software application for producing the message by providing means for inputting the message and means for addressing the message to the intended addressee;
b) an electromagnetic transmitter; and
c) a message processing device for processing the message including encoding the message in a form that can be transmitted addressed to the intended addressee and then sending the message from the software application to the electromagnetic transmitter,
whereby the message is transmitted from the electromagnetic transmitter with the express intent that the message not be received by the intended addressee.

13. The system of claim 12, wherein the share is effected by a transmission selected from the group consisting of email, a webpage, social media, cellphone text messaging, and combinations thereof.

14. The system of claim 12, further comprising means to transmit an attachment with the message.

15. The system of claim 12, wherein the intended addressee is a deceased person.

16. A method of sending a message with the express intent that the message not be received by an intended addressee, comprising:
a) inputting a message into a data processing device configured to collect the message;
b) transmitting the message to a message processing device to encode the message for an electromagnetic transmitter and/or transmit to the message to the electromagnetic transmitter configured to direct electromagnetic waves from the electromagnetic transmitter;
c) transmitting the message in electromagnetic waves.

17. The method of claim 16, wherein the method is carried out by a system comprising:
a) a data processing device configured to collect the message;
b) the electromagnetic transmitter; and
c) the message processing device,
whereby the message is transmitted from the electromagnetic transmitter with the express intent that the message not be received by the intended addressee.

18. The method of claim 16, wherein the method is carried out by a system comprising:
a) a software application residing on a device having a CPU capable of running the software application, the software application for producing the message by providing means for inputting the message and means for addressing the message to the intended addressee;
b) the electromagnetic transmitter; and
c) the message processing device for processing the message includes encoding the message in a form that can be transmitted addressed to the intended addressee and then sending the message from the software application to the electromagnetic transmitter,
whereby the message is transmitted from the electromagnetic transmitter with the express intent that the message not be received by the intended addressee.

19. The system of claim 16, wherein the intended addressee is a deceased person.
